(19) United States
(12) Patent Application Publication
(10) Pub. No.: US 2022/0166267 A1
(43) Pub. Date: May 26, 2022

(54) A STATOR AND STATOR HOUSING

(71) Applicant: Jaguar Land Rover Limited, Coventry, Warwickshire (GB)

(72) Inventors: Tiago CESA, Coventry, Warwickshire (GB); Alexandros MICHAELIDES, Coventry, Warwickshire (GB)

(21) Appl. No.: 17/297,987

(22) PCT Filed: Sep. 12, 2019
(86) PCT No.: PCT/EP2019/074369

§ 371 Date: May 27, 2021

(30) Foreign Application Priority Data
Nov. 28, 2018 (GB) 1819334.2

(51) Int. Cl. H02K 1/18; H02K 15/02

(52) U.S. Cl. CPC H02K 1/185; B60K 1/00; H02K 15/028

(57) ABSTRACT

A stator and a stator housing for an electric machine is disclosed. The stator housing comprises an opening to receive the stator in a direction extending along a longitudinal axis of the electric machine to enable the stator housing to be shrink-fitted to the stator. The shape of the opening in the stator housing lying in a cross-sectional plane perpendicular to the longitudinal axis comprises four quarter circle arcs, with at least two of the quarter circle arcs being separated by a non-zero distance, the stator having a corresponding shape to the stator housing.

### TECHNICAL FIELD

The present disclosure relates to a stator and a stator housing for an electric machine such as a motor or generator. Aspects of the invention relate to a stator for an electric machine, to a stator housing for an electric machine, to an electric machine assembly comprising the stator and stator housing, to a drive system for an electric vehicle, and to a vehicle incorporating the drive system.

### BACKGROUND

It is known to provide an electric motor having a rotor which turns a shaft to deliver mechanical power, and a stationary stator made up of steel laminations that surround the rotor. The rotor and stator are received in an aluminium stator housing which is shrink-fitted to the stator. i.e. the stator housing is heated so that it expands allowing the stator to fit inside. When the stator housing cools, the stator housing and the stator mate closely with each other and maintain tight contact so that heat is dissipated from the stator to the stator housing efficiently.

In an electric motor, the rotor generates torque which must be counteracted by the stator. However, as aluminium has a greater coefficient of thermal expansion than steel, the stator housing may expand more than the stator at higher temperatures resulting in undesirable rotation of the stator relative to the stator housing.

It is known to prevent rotation of the stator relative to the stator housing by providing a key on the stator which locates in a keyway formed in the stator housing. The key and keyway engage with each other to prevent relative rotation of the stator and stator housing.

A problem with the known key and keyway solution is that, whilst relative rotation of the stator and stator housing is prevented, high stress concentrations in the stator and stator housing in the regions surrounding the key and the keyway can be generated due to bending forces at high operating temperatures. In some electric motors, this problem is mitigated by allowing some ‘give’ in the construction of the stator laminations, which reduces the overall rigidity of the stator and allows some flexibility. However, to increase performance and reduce cost, it is becoming more common to glue stator laminations together which results in increased stator rigidity and a lower ability to flex in order to dissipate stress.

It is an aim of the present invention to address one or more of the disadvantages associated with the prior art.

### SUMMARY OF THE INVENTION

Aspects and embodiments of the invention provide a stator and a stator housing for an electric machine, a stator for an electric machine, a stator housing for an electric machine, an electric machine assembly comprising the stator and stator housing, a drive system for an electric vehicle, and a vehicle incorporating the drive system, as claimed in the appended claims.

According to an aspect of the present invention there is provided a stator and a stator housing for an electric machine, the stator and the stator housing each including:

a. a primary arcuate surface that extends about a longitudinal axis, said primary arcuate surfaces of each of the stator and stator housing being configured to mate when the stator housing is shrink-fitted to the stator to couple the stator housing to the stator, and
b. a secondary surface interrupting the primary arcuate surface of each of the stator and stator housing, the secondary surface of the stator and stator housing each having at least a portion that lies radially beyond the primary arcuate surface of the stator and stator housing, respectively,
c. wherein the secondary surface of each of the stator and stator housing mate when the stator housing is shrink-fitted to the stator to prevent rotation of the stator relative to the stator housing during operation of the electric machine.

This provides the advantage that stress concentrations in the stator and stator housing may be reduced.

In an embodiment, the secondary surface of each of the stator and stator housing is arcuate, and extends about the same longitudinal axis, the radius of curvature of the secondary arcuate surface of the stator being greater than the radius of curvature of the primary arcuate surface of the stator, and the radius of curvature of the secondary arcuate surface of the stator housing being greater than the radius of curvature of the primary arcuate surface of the stator housing.

In another embodiment, the secondary surface of each of the stator and the stator housing is arcuate, and each of them extend about the same axis which is parallel to said longitudinal axis.

Optionally, the primary and secondary arcuate surfaces of the stator each have a radius of curvature, wherein the radius of curvature of the primary arcuate surface, and secondary arcuate surface, of the stator are the same.

Alternatively, the radius of curvature of the secondary arcuate surface of the stator may be less that the radius of curvature of the primary arcuate surface of the stator.

In some embodiments, the primary and secondary arcuate surfaces of the stator housing each have a radius of curvature and the radius of curvature of the primary and secondary arcuate surfaces of the stator housing may be the same.

Alternatively, the radius of curvature of the secondary arcuate surface of the stator housing may be less than the radius of curvature of the primary arcuate surface of the stator housing.

Optionally, the stator may comprise an intermediate region between the primary and secondary arcuate surfaces of the stator that comprises a depression extending below the primary arcuate surface of the stator so that, when the stator housing is coupled to the stator, a gap exists between the stator and the stator housing which is formed by said intermediate region.

In embodiments, the intermediate region may be arcuate.

The stator housing may comprise an arcuate external surface. Optionally, a radial distance between the primary arcuate surface of the stator housing and said external surface is the same as a radial distance between the secondary arcuate surface of the stator housing and said external surface.

Alternatively, a radial distance between the primary arcuate surface of the stator housing and said external surface may be less than a radial distance between the secondary arcuate surface of the stator housing and said external surface.

In embodiments, the arcuate external surface of the stator housing comprises a region corresponding to said secondary arcuate surface, said region having a radius of curvature that is the same as the radius of curvature of said secondary arcuate surface.

Alternatively, said region has a radius of curvature that is greater than the radius of curvature of said secondary arcuate surface.

In embodiments, the primary and secondary arcuate surfaces have a longitudinal dimension that extends in a direction along the axis, said longitudinal dimension corresponding to the length of the stator and stator housing.

According to another aspect of the invention, there is provided a stator for an electric machine, comprising:

a. a primary arcuate surface that extends about a longitudinal axis, and
b. a secondary surface interrupting the primary arcuate surface, said secondary surface having at least a portion that lies radially beyond said primary arcuate surface,
c. said primary arcuate surface, and the secondary surface, being configured to engage a stator housing when said stator housing is shrink-fitted to the stator to prevent rotation of the stator relative to the stator housing during operation of the electric machine.

Optionally, the secondary surface is arcuate, and extends about the same longitudinal axis, or an axis parallel to said longitudinal axis.

According to yet another aspect of the invention, there is provided a stator housing for an electric machine, comprising:

a. a primary arcuate surface that extends about a longitudinal axis, and
b. a secondary surface interrupting the primary arcuate surface, said secondary surface having at least a portion that lies radially beyond said primary arcuate surface,
c. said primary arcuate surface, and the secondary surface, being configured to engage a stator when the stator housing is shrink-fitted to the stator to prevent rotation of the stator relative to the stator housing during operation of the electric machine.

According to a further aspect of the invention, there is provided an electric machine assembly comprising a stator and stator housing according to the invention.

According to a still further aspect of the invention, there is provided an electric machine comprising the electric machine assembly according to the invention, and comprising a rotor mounted for rotation within the stator.

According to another aspect of the invention, there is provided a drive system for an electric vehicle incorporating an electric machine according to the invention.

According to a final aspect of the invention, there is provided an electric vehicle comprising the drive system according to the invention.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows an end view of a stator;

FIG. 2 shows an end view of a stator housing;

FIG. 3 shows a partial end view of the stator housing of FIG. 2 shrink-fitted to the stator of FIG. 1;

FIG. 3A shows another partial end view of the stator housing of FIG. 2 shrink-fitted to the stator of FIG. 1, according to one embodiment;

FIG. 4 shows a partial end view of the stator housing of FIG. 2;

FIG. 5 shows a partial end view of the stator of FIG. 1;

FIG. 6 shows an exploded perspective view of an electric motor;

FIG. 7 shows an assembled view of the electric motor of FIG. 6;

FIG. 8 shows a drive system for an electric vehicle that includes the electric motor of FIGS. 6 and 7; and

FIG. 9 shows a vehicle in accordance with an embodiment of the invention.

### DETAILED DESCRIPTION

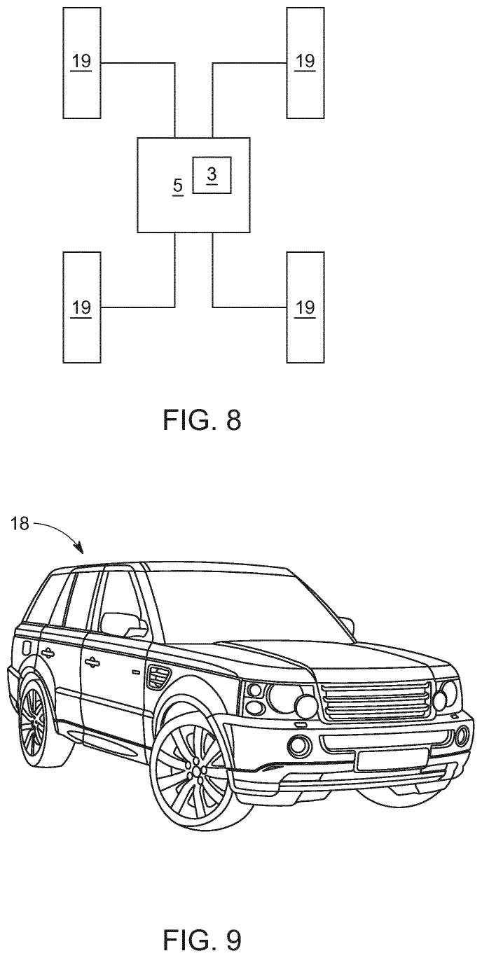

A stator 1 and a stator housing 2 for an electric machine 3 (see FIG. 7) in accordance with an embodiment of the present invention is described herein with reference to the accompanying Figures. Also described herein in accordance with embodiments of the present invention are a stator 1 for an electric machine 3, a stator housing 2 for an electric machine 3, an electric machine assembly 4 comprising the stator 1 and stator housing 2, a drive system 5 (see FIG. 8) for an electric vehicle 18, and to a vehicle 18 incorporating the drive system 5 (see FIG. 9).

Embodiments of the invention are described with reference to an electric motor. However, other types of electric machines are within the scope of the invention, such as electric generators.

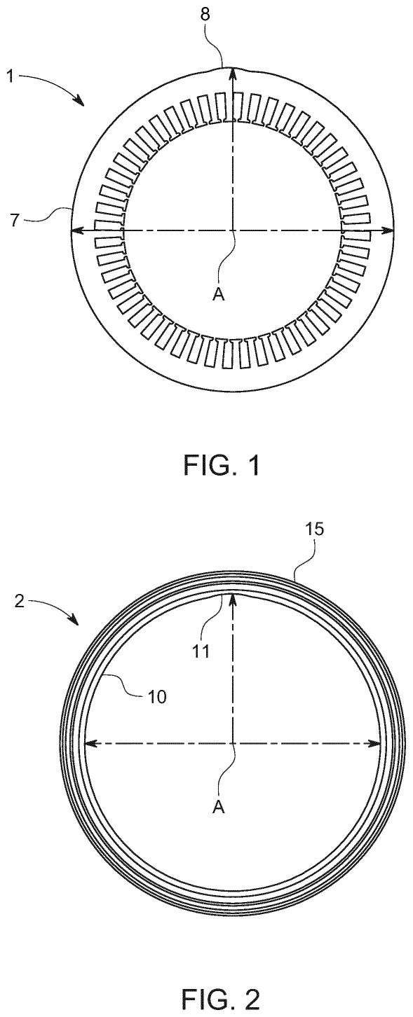

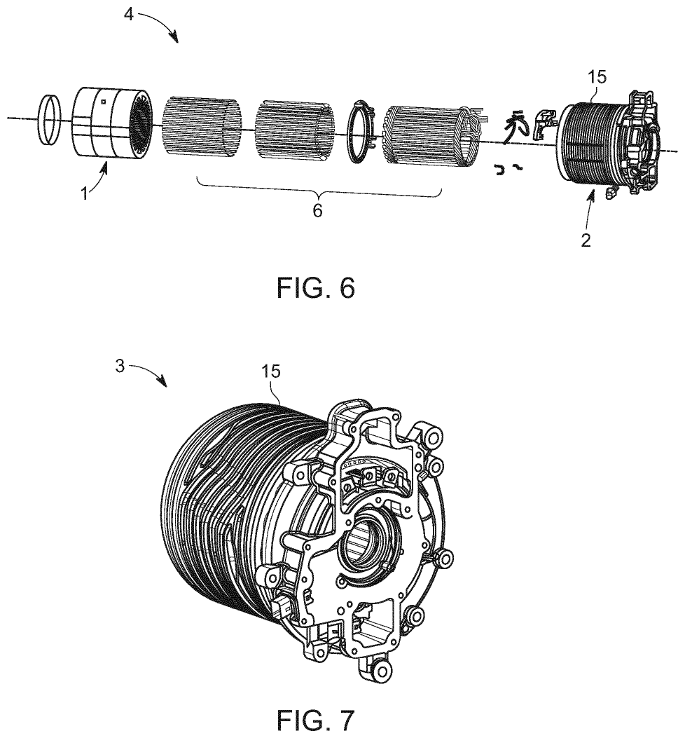

With particular reference to FIGS. 1 and 5, there is shown an end view of stator 1 formed from a plurality of steel laminations. The stator 1 has a primary arcuate outer surface 7 extending about a longitudinal axis A. Upon assembly, a rotor 6 (see FIG. 6) is received within the stator 1 so that it will rotate about the longitudinal axis A. The primary arcuate outer surface 7 defines the entire outer periphery of the stator 1, apart from one longitudinally extending region where a deformity is formed, in the otherwise continuously curved outer surface 7 of the stator 1, and which interrupts the primary arcuate surface 7. The deformity comprises a secondary arcuate surface 8 that has a portion which extends in a radial direction beyond the primary arcuate surface 7, as most clearly shown in FIG. 5.

With reference to the stator 1 shown in FIG. 5, the secondary arcuate surface 8 extends radially beyond the primary arcuate surface 7, a continuation of which is represented in dashed lines 9 below the secondary arcuate surface 8.

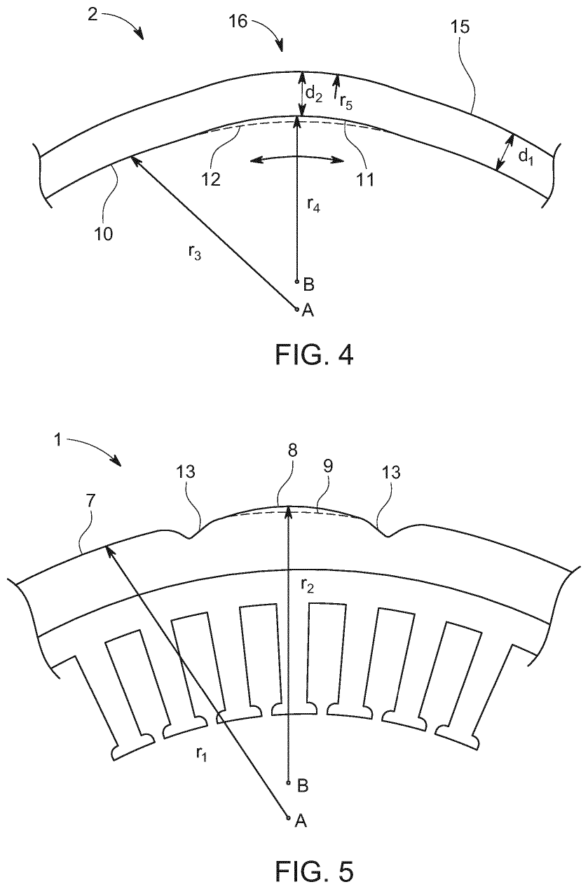

With particular reference to FIGS. 2 and 4, there is shown an end view of a tubular stator housing 2 formed from aluminium. The stator housing 2 has a primary arcuate inner surface 10 extending about the same longitudinal axis A. The primary arcuate inner surface 10 defines the entire inner periphery of the stator housing 2, apart from one longitudinally extending region where a deformity is formed, in the otherwise continuously curved inner surface 10 of the stator housing 2, which interrupts the primary arcuate inner surface 10. The deformity comprises a secondary arcuate inner surface 11 that has a portion which extends in a radial direction beyond the primary arcuate inner surface 10, as most clearly shown in FIG. 4. With reference to the stator housing 2 shown in FIG. 4, the secondary arcuate inner surface 11 extends radially beyond the primary arcuate inner surface 10, a continuation of which is represented in dashed lines 12 below the secondary arcuate inner surface 11.

Upon assembly, the stator housing 2 is shrink-fitted to the stator 1 by heating the stator housing 2 so that it expands sufficiently to enable the stator 1 to be slid within it. Once the stator 1 is located within the stator housing 2, the assembly is allowed to cool so that the stator housing 2 contracts to apply pressure to the stator 1. Once the stator housing 2 contracts to apply pressure to the stator 1, the stator housing 2 and stator abut, bind or mate with the stator 1. More specifically, the primary arcuate inner surface 10 of the stator housing 2 is squeezed tightly against the primary arcuate outer surface 7 of the stator 1.

Further, when the stator 1 is slid into the stator housing 2, the secondary arcuate outer surface 8 of the stator 1 is aligned with the secondary arcuate inner surface 11 of the stator housing 2, so that the secondary arcuate inner surface 11 of the stator housing 2 will also shrink fit and apply pressure to the secondary arcuate outer surface 8 of the stator 1, so that the secondary arcuate surfaces 8, 11 bind or mate with each other in the same way as the primary arcuate surfaces 7,10.

As a result of the secondary arcuate surfaces 8, 11 mating with each other in addition to mating of the primary arcuate surfaces 7, 10 due to the shrink-fitting process, rotation of the stator 1 relative to the stator housing 2 is prevented because the secondary arcuate surfaces 8, 11 extend radially beyond their corresponding primary arcuate surfaces 7, 10. Furthermore, the generation of undesirable stress concentrations in the stator 1, or in the stator housing 2, is also avoided, particularly in a region surrounding the secondary arcuate surfaces 8, 11. It will be understood that the arcuate or curved profile of the secondary arcuate surfaces 8, 11 helps to reduce stress concentrations in both the stator 1 and stator housing 2 in the region surrounding the secondary arcuate surfaces 8, 11 of the stator 1 and stator housing 2.

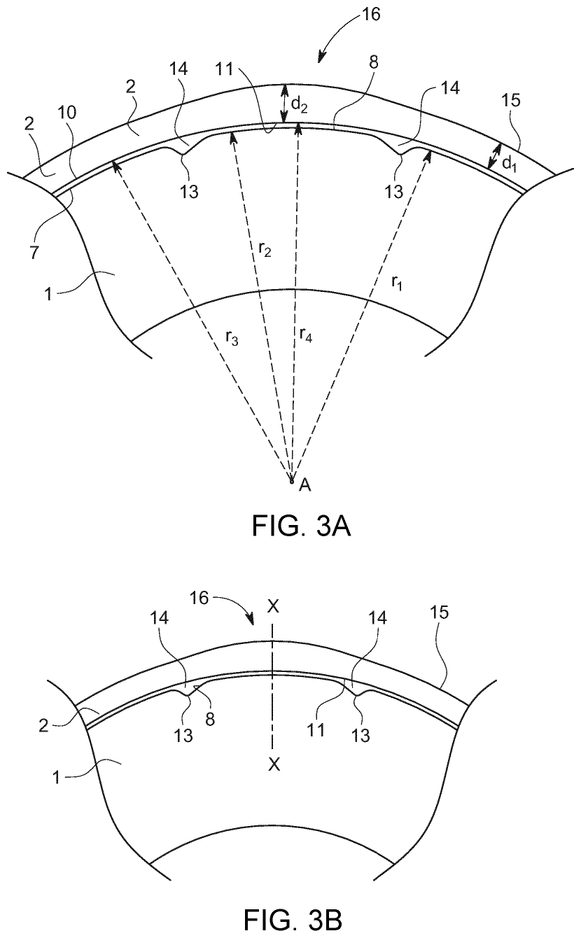

Reference will now be made to FIG. 3, which shows a portion of the stator 1, and the stator housing 2, after the stator housing 2 has been shrink-fitted to the stator 1, in a region of the secondary arcuate surfaces 8, 11. Although in FIG. 3, a narrow gap can be seen as being present between the stator 1 and stator housing 2, this is for illustrative purposes only, as the stator housing 2 mates with the stator 1 following the shrink-fit process, both between the primary arcuate surfaces 7, 10 and between the secondary arcuate surfaces 8, 11. Therefore, a continuous gap, as shown, will not be present.

From FIG. 3, it will be appreciated that the primary and secondary arcuate surfaces 7, 8 of the stator 1, as well as the primary and secondary arcuate surfaces 10, 11 of the stator housing 2, all have the same axis namely, the longitudinal axis A of the stator 1 and stator housing 2 about which the rotor 6 rotates. In this embodiment, and so that at least a portion of the secondary arcuate outer surface 9 of the stator 1 lies radially beyond the primary arcuate outer surface of the stator 7, the radius (r₂) of the secondary arcuate outer surface 8 of the stator 1 is greater than the radius (r₁) of the primary arcuate outer surface 7 of the stator 1. Similarly, the radius (r₄) of the secondary arcuate inner surface 11 of the stator housing 2 is greater than the radius (r₃) of the primary arcuate inner surface 10 of the stator housing 2.

Other embodiments will be described with reference to FIGS. 4 and 5. In these embodiments, the axis of the primary arcuate outer surface 7 of the stator 1 and the primary arcuate inner surface 10 of the stator housing 2 are coaxial with the longitudinal axis A of the stator 1 and stator housing 2 about which the rotor 6 rotates. However, the longitudinal axis B of the secondary arcuate outer surface 8 of the stator 1 and the secondary arcuate inner surface 11 of the stator housing 2 is spaced from, and is parallel to, the longitudinal axis (A), as shown. In some embodiments, the radius (r₂) of the secondary arcuate outer surface 8 of the stator 1 is equal to the radius (r₁) of the primary arcuate outer surface 7 of the stator 1. In other embodiments, the radius (r₂) of the secondary arcuate outer surface 8 of the stator 1 is less than the radius (r₁) of the primary arcuate outer surface 7 of the stator 1. In either case, the radius (r₃) of the primary arcuate inner surface 10 of the stator housing 2 can be equal to the radius (r₄) of the secondary arcuate inner surface 11 of the stator housing 2, or the radius (r₄) of the secondary arcuate outer surface 11 of the stator housing 2 can be less than the radius (r₃) of the primary arcuate inner surface 10 of the stator housing 2.

With reference to FIG. 3A, if the radius (r₂) of the secondary arcuate outer surface 8 of the stator 1 is less than the radius (r₄) of the secondary arcuate inner surface 11 of the stator housing 2, only a relatively small central region of the secondary arcuate outer surface 8 of the stator 1 (i.e. a region about the radial centre line X-X in FIG. 3A) will mate with the secondary arcuate inner surface 11 of the stator housing 2, with the secondary arcuate surfaces 8, 11, gradually and smoothly separating from each other in each circumferential direction away from the radial centre line X-X. This smooth separation of the secondary arcuate surfaces 8, 11 from each other further assists in reducing the generation of stress concentrations in this area of the stator 1 and stator housing 2.

To further reduce stress concentrations in the stator 1, there is an intermediate region 13 between the primary arcuate outer surface 7 and the secondary arcuate surface 8 of the stator 1. This intermediate region 13 may comprise a concave or curved depression extending radially inwardly of the stator 1, below the primary arcuate surface 7. When the stator housing 2 has been shrink-fitted to the stator 1, the curved depression 13 on either side of the secondary arcuate outer surface 8, where it meets the primary arcuate outer surface 7, forms a stress-relieving gap 14 between the stator 1 and stator housing 2, in addition to any gap that may be present due to any unequal radius of curvature of the secondary arcuate outer surface 8 of the stator 1 and the secondary arcuate inner surface 11 of the stator housing 2.

The stator housing 2 has an arcuate external surface 15 and the radial thickness of the stator housing 2 may remain constant irrespective of the secondary arcuate inner surface 11. In particular, and with reference to FIG. 3, the radial thickness (d₁) between the primary arcuate inner surface 10 of the stator housing 2 and the arcuate external surface 15 of the stator housing 2 may be the same as the radial thickness (d₂) between the secondary arcuate inner surface 11 of the stator housing 2 and the arcuate external surface 15 of the stator housing 2. In order to ensure that d₁=d₂, the external arcuate surface 15 of the stator housing 2 may bulge outwardly in a region 16 corresponding to the secondary inner arcuate surface 11.

It is also envisaged that the radial thickness d₂ may be greater than the radial thickness d₁. The region of the external arcuate surface 16 of the stator housing 2 that bulges outwardly may have a radius of curvature (r₅), which is either the same as, or greater than, the radius (r₄) of curvature of the secondary arcuate inner surface 11 of the stator housing 2.

The secondary arcuate surfaces 8, 11 of the stator 1 and stator housing 2 each extend in a longitudinal direction for the full length of the stator 1 and stator housing 2. However, it is possible that the secondary arcuate surfaces 8, 11 could extend from one end for only part of the total length of the stator 1 and stator housing 2.

With reference to FIG. 6, there is shown an electric motor assembly 4 comprising the stator 1, the stator housing 2 and the rotor 6 according to embodiments of the invention. An assembled electric motor 3 according to embodiments is also shown in FIG. 7.

The electric motor 3 may form part of the drive system 5 for an electric vehicle 18 shown in FIG. 9, the drive system 5 being schematically shown in FIG. 8. The drive system 5 includes the electric motor 3 which is operatively connected to some, or all, of the wheels 19 of the vehicle 18.

It will be appreciated that the electric motor 3 according to embodiments of the invention may also be employed for tasks other than for providing the main driving force of the vehicle 18.

It will be appreciated that various changes and modifications can be made to the present invention without departing from the scope of the present application.

The following numbered clauses define various further aspects and features of the present technique:

1. A stator and a stator housing for an electric machine, the stator and the stator housing each including:
a primary arcuate surface that extends about a longitudinal axis, said primary arcuate surfaces of each of the stator and stator housing being configured to mate when the stator housing is shrink-fitted to the stator to couple the stator housing to the stator, and
a secondary surface interrupting the primary arcuate surface of each of the stator and stator housing, the secondary surface of the stator and stator housing each having at least a portion that lies radially beyond the primary arcuate surface of the stator and stator housing, respectively,
wherein the secondary surface of each of the stator and stator housing mate when the stator housing is shrink-fitted to the stator to prevent rotation of the stator relative to the stator housing during operation of the electric machine.
   2. A stator and stator housing according to clause 1, wherein the secondary surface of each of the stator and stator housing is arcuate, and extends about the same longitudinal axis, the radius of curvature of the secondary arcuate surface of the stator being greater than the radius of curvature of the primary arcuate surface of the stator, and the radius of curvature of the secondary arcuate surface of the stator housing being greater than the radius of curvature of the primary arcuate surface of the stator housing.
   3. A stator and stator housing according to clause 1, wherein the secondary surface of each of the stator and the stator housing is arcuate, and extends about an axis parallel to said longitudinal axis.
   4. A stator and stator housing according to clause 3, wherein the primary and secondary arcuate surfaces of the stator each have a radius of curvature, wherein the radius of curvature of the primary and secondary arcuate surfaces of the stator are the same.
   5. A stator and stator housing according to clause 3, wherein the primary and secondary arcuate surfaces of the stator each have a radius of curvature, said radius of curvature of the secondary arcuate surface of the stator being less that the radius of curvature of the primary arcuate surface of the stator.
   6. A stator and stator housing according to clauses 4 or 5, wherein the primary and secondary arcuate surfaces of the stator housing each have a radius of curvature said radius of curvature of the primary and secondary arcuate surfaces of the stator housing being the same.
   7. A stator and stator housing according to clause 5, wherein the primary and secondary arcuate surfaces of the stator housing each have a radius of curvature, said radius of curvature of the secondary arcuate surface of the stator housing being less than the radius of curvature of the primary arcuate surface of the stator housing.
   8. A stator and stator housing according to any preceding clause, comprising an intermediate region between the primary and secondary arcuate surfaces of the stator that comprises a depression extending below the primary arcuate surface of the stator so that, when the stator housing is coupled to the stator, a gap exists between the stator and the stator housing which is formed by said intermediate region.
   9. A stator and stator housing according to clause 8, wherein said intermediate region is arcuate.
   10. A stator and stator housing according to any preceding clause, wherein the stator housing comprises an arcuate external surface and a radial distance between the primary arcuate surface of the stator housing and said external surface is the same as a radial distance between the secondary arcuate surface of the stator housing and said external surface.
   11. A stator and stator housing according to any of clauses 1 to 10, wherein the stator housing comprises an arcuate external surface and a radial distance between the primary arcuate surface of the stator housing and said external surface is less than a radial distance between the secondary arcuate surface of the stator housing and said external surface.
   12. A stator and stator housing according to clause 10 or clause 11, wherein the arcuate external surface of the stator housing comprises a region corresponding to said secondary arcuate surface, said region having a radius of curvature that is the same as the radius of curvature of said secondary arcuate surface.
   13. A stator and stator housing according to clause 11 or clause 12, wherein the arcuate external surface of the stator housing comprises a region corresponding to said secondary arcuate surface, said region having a radius of curvature that is greater than the radius of curvature of said secondary arcuate surface of the stator housing.
   14. A stator and stator housing according to any preceding clause, wherein said primary and secondary arcuate surfaces of each of the stator and stator housing have a longitudinal dimension that extends in a direction along the axis A, said longitudinal dimension corresponding to the length of the stator and stator housing.
   15. A stator for an electric machine, comprising:
a primary arcuate surface that extends about a longitudinal axis, and
a secondary surface interrupting the primary arcuate surface, said secondary surface having at least a portion that lies radially beyond said primary arcuate surface,
said primary arcuate surface, and the secondary surface, being configured to engage a stator housing when said stator housing is shrink-fitted to the stator to prevent rotation of the stator relative to the stator housing during operation of the electric machine.
   16. A stator according to clause 15, wherein the secondary surface is arcuate, and extends about the same longitudinal axis, or an axis parallel to said longitudinal axis.
   17. A stator housing for an electric machine, comprising:
a primary arcuate surface that extends about a longitudinal axis, and
a secondary surface interrupting the primary arcuate surface, said secondary surface having at least a portion that lies radially beyond said primary arcuate surface,
said primary arcuate surface, and the secondary surface, being configured to engage a stator when the stator housing is shrink-fitted to the stator to prevent rotation of the stator relative to the stator housing during operation of the electric machine.
   18. An electric machine assembly comprising a stator and stator housing according to any of clauses 1 to 14, the stator housing being a shrink-fit on the stator.
   19. An electric machine comprising the electric machine assembly according to clause 18, and comprising a rotor mounted for rotation within the stator.
   20. A drive system for an electric vehicle incorporating an electric machine according to clause 19.
   21. A vehicle incorporating the drive system of clause 20.

1. A stator and a stator housing for an electric machine, the stator housing comprising an opening to receive the stator in a direction extending along a longitudinal axis of the electric machine to enable the stator housing to be shrink-fitted to the stator, wherein the shape of the opening in the stator housing lying in a cross-sectional plane perpendicular to the longitudinal axis comprises four quarter circle arcs, with at least two of the quarter circle arcs being separated by a non-zero distance, the stator having a corresponding shape to the stator housing.

2. The stator and the stator housing according to claim 1, wherein each of the four quarter circle arcs is separated from each of the other of the four quarter circle arcs by a non-zero distance, or wherein the shape of the opening lying in said cross-sectional plane comprises a first line extending between one end of each of two of said four quarter circle arcs, and a second line extending between one end of each of the other two quarter circle arcs.

3. The stator and the stator housing according to claim 2, wherein the first and second lines are straight and parallel to each other, each of said first and second lines extending at a tangent to said ends of said quarter circle arcs.

4. The stator and the stator housing according to claim 2, wherein the opposite ends of two of the four quarter circle arcs which do not have either the first or second lines extending between them, are connected by a third line, the opposite ends of the other two quarter circle arcs, which do not have either the first or second lines extending between them, also being connected by a fourth line.

5. The stator and the stator housing according to claim 4, wherein the third and fourth lines are straight and parallel to each other, each of said third and fourth lines extending at a tangent to the opposite ends of said quarter circle arcs, and optionally wherein the shape of the opening in the stator housing in a cross-sectional plane perpendicular to the longitudinal axis is a rounded square.

6. The stator and the stator housing according to claim 2, wherein the opposite ends of two of the four quarter circle arcs have a zero distance between them, the opposite ends of the other two of the four quarter circle arcs also having a zero distance between them, and optionally wherein shape of the opening in the stator housing lying in a cross-sectional plane perpendicular to the longitudinal axis is obround.

7. The stator (1) and stator housing for the electric machine according to claim 1, wherein the shape of the opening in the stator housing lying in a cross-sectional plane perpendicular to the longitudinal axis at any point along said longitudinal axis is the same.

8-11. (canceled)

12. A method of manufacturing the stator housing for the electric machine, the stator housing comprising an opening configured to receive a stator inserted into the opening in a direction extending along a longitudinal axis of the electric machine to enable the stator housing to be shrink-fitted to the stator, the method of manufacturing the stator housing comprising:
plunging a circular cutting tool in a first axial direction into material from which the stator housing is to be formed to form a circular opening,
translating the circular cutting tool in a first direction extending at right-angles to the longitudinal axis; and
removing said circular cutting tool in a second axial direction, optionally wherein translating the circular cutting tool in a direction extending at right-angles to the longitudinal axis forms an opening in said material that has a shape, lying in a cross-sectional plane perpendicular to the longitudinal axis, which is obround.

13. The method according to claim 12, comprising, following said translating the circular cutting tool in the first direction extending at right-angles to the longitudinal axis and prior to removing said circular cutting tool in the second axial direction:
translating the circular cutting tool in a second direction extending at right angles to the longitudinal axis and at right angles to the first direction;
translating the circular cutting tool in a third direction extending at right-angles to the longitudinal axis in a direction opposite and parallel to the first direction;
translating the circular cutting tool in a fourth direction extending at right angles to the longitudinal axis and at right angles to the first direction, in a direction opposite and parallel to the second direction, optionally
wherein translating the circular cutting tool in said first, second, third and fourth directions forms an opening in said material that has a shape, lying in a cross-sectional plane perpendicular to the longitudinal axis, which is a rounded square.

14. The method according to claim 12, comprising:
removing said circular cutting tool in a second axial direction following said plunging the circular cutting tool in the first axial direction and prior to translating the circular cutting tool in the first direction extending at right-angles to the longitudinal axis;
plunging said circular cutting tool in the first axial direction following said translating the circular cutting tool in the first direction extending at right-angles to the longitudinal axis.

15. An electric machine assembly comprising the stator and the stator housing of any of claims 1 to 10, and a rotor mounted for rotation about the longitudinal axis within the stator, in which the stator housing is shrink-fitted to the stator.

16. (canceled)

17. A vehicle incorporating the stator and stator housing according to claim 1.
